(19) United States
(12) Patent Application Publication
(10) Pub. No.: US 2015/0161771 A1
(43) Pub. Date: Jun. 11, 2015

(54) IMAGE PROCESSING METHOD, IMAGE PROCESSING APPARATUS, IMAGE CAPTURING APPARATUS AND NON-TRANSITORY COMPUTER-READABLE STORAGE MEDIUM

(71) Applicant: CANON KABUSHIKI KAISHA, Tokyo (JP)

(72) Inventor: Norihito HIASA, Utsunomiya-shi (JP)

(21) Appl. No.: 14/563,388

(22) Filed: Dec. 8, 2014

(30) Foreign Application Priority Data
Dec. 11, 2013 (JP) 2013-255643

(51) Int. Cl. G06T 5/00; G06K 9/62; G06T 7/40; G06K 9/46

(52) U.S. Cl. CPC G06T 5/00; G06K 9/46; G06K 9/6201; G06T 7/408; G06K 2009/4666

(57) ABSTRACT

The image processing method includes extracting a range block image from an input image produced by image capturing, acquiring a degradation function representing degradation caused in the range block image by the image capturing, acquiring at least one first domain block image from the input image or another image, and applying the degradation function to the first domain block image to produce a second domain block image. The method further includes calculating a correlation between the second domain block image and the range block image, selecting from the at least one first domain block image, depending on the correlation, a corresponding domain block image that corresponds to the range block image, and producing an output image by using the corresponding domain block image.

### BACKGROUND OF THE INVENTION

1. Field of the Invention

The present invention relates to a technique of performing image processing on an image produced by image capturing in order to increase quality of the image.

2. Description of the Related Art

An image produced by an image capturing apparatus generally includes degradation, that is, decrease in its quality caused by aberration, diffraction and defocus of an image capturing optical system of the image capturing apparatus and by image blur due to shaking of the apparatus with user's hand jiggling. As a method of correcting an image including such degradation (hereinafter referred to also as “a degraded image”) to increase its quality, a method is proposed which applies an inverse filter such as a Wiener filter to the degraded image. However, the correction method using the inverse filter has a difficulty in sufficiently correcting (restoring) a frequency component of the degraded image whose MTF (Modulation Transfer Function) is significantly lowered due to the degradation.

In order to overcome the difficulty, International Publication WO2007/074649 discloses a method of inserting, to an optical system, a wavefront coding optical element (such as a phase plate) that deforms a wavefront of an imaging light to suppress decrease in MTF in a direction of depth of field. In addition, “Image super resolution using fractal coding” (Opt. Eng. January 2008/Vol. 47(1)017007, Y. Chen, et al.) discloses a method of applying an identical inverse filter to a range block image and a domain block image to perform a blur correction and then producing by utilizing fractal coding an image whose number of pixels is increased.

However, the method disclosed in International Publication WO2007/074649 suppresses the decrease in MTF in a defocus area and therefore cannot provide such an effect in an in-focus area. That is, this method can extend the depth of field and cannot restore a frequency component whose MTF is significantly lowered due to aberration and the like. Furthermore, this method requires, when image capturing is performed, a special optical system into which the wavefront coding optical element is inserted, which makes it impossible to correct an already captured image.

Moreover, the method disclosed in “Image super resolution using fractal coding” (Opt. Eng. January 2008/Vol. 47(1)017007, Y. Chen, et al.) performs the blur correction by a conventional approach that uses the inverse filter. Therefore, this method cannot provide a sufficient blur-correction effect in a case where the degradation due to blur is significant and thereby the MTF of a low frequency component is also significantly lowered. In addition, this method may generate ringing in the image to which the inverse filter has been applied and therefore may not correctly provide a domain block image having a shape homothetic to that of the range block image.

### SUMMARY OF THE INVENTION

The present invention provides an image processing method, an image processing apparatus and an image capturing apparatus each capable of sufficiently restoring, of an input image, even a frequency component whose MTF is significantly lowered by degradation due to image capturing.

The present invention provides as an aspect thereof an image processing method including extracting a range block image from an input image produced by image capturing, acquiring a degradation function representing degradation caused in the range block image by the image capturing, acquiring at least one first domain block image from the input image or another image, applying the degradation function to the first domain block image to produce a second domain block image, calculating a correlation between the second domain block image and the range block image, selecting from the at least one first domain block image, depending on the correlation, a corresponding domain block image that corresponds to the range block image, and producing an output image by using the corresponding domain block image.

The present invention provides as another aspect thereof an image processing apparatus including an extractor configured to extract a range block image from an input image produced by image capturing, a first acquirer configured to acquire a degradation function representing degradation caused in the range block image by the image capturing, a second acquirer configured to acquire at least one first domain block image from the input image or another image, a first producer configured to apply the degradation function to the first domain block image to produce a second domain block image, a calculator configured to calculate a correlation between the second domain block image and the range block image, a selector configured to select from the at least one first domain block image, depending on the correlation, a corresponding domain block image that corresponds to the range block image, and a second producer configured to produce an output image by using the corresponding domain block image.

The present invention provides as still another aspect thereof an image capturing apparatus including an image capturer configured to perform image capturing, and the above image processing apparatus.

The present invention provides as yet another aspect thereof a non-transitory computer-readable storage medium storing an image processing program as a computer program to cause a computer to execute an image process. The image process includes extracting a range block image from an input image produced by image capturing, acquiring a degradation function representing degradation caused in the range block image by the image capturing, acquiring at least one first domain block image from the input image or another image, applying the degradation function to the first domain block image to produce a second domain block image, calculating a correlation between the second domain block image and the range block image, selecting from the at least one first domain block image, depending on the correlation, a corresponding domain block image that corresponds to the range block image, and producing an output image by using the corresponding domain block image.

Other aspects of the present invention will become apparent from the following description and the attached drawings.

### BRIEF DESCRIPTION OF THE DRAWINGS

FIG. 1 is a block diagram of an image capturing apparatus that performs an image processing method that is Embodiment 1 of the present invention.

FIG. 2 is an external view of the image capturing apparatus.

FIG. 3 is a flowchart illustrating image processing in Embodiment 1 (and Embodiments 2 and 3).

FIGS. 4A and 4B explain on acquisition of a range block image and a domain block image in Embodiment 1 (and Embodiments 2 and 3).

FIG. 5 explains a method of acquiring the domain block image to be used for a correlation calculation in Embodiments 1 to 3.

FIGS. 6A and 6B illustrate a relation between a degradation function and the range block image and a relation between the degradation function and the domain block image to be used for the correlation calculation in Embodiments 1 to 3.

FIG. 7 is a block diagram illustrating a configuration of an image processing system that is Embodiment 2.

FIG. 8 is an external view of the image processing system that is Embodiment 2.

FIG. 9 is a block diagram illustrating a configuration of an image capturing apparatus that is Embodiment 3.

FIG. 10 is an external view of the image capturing apparatus in Embodiment 3.

FIG. 11 illustrates the configuration of the image capturing apparatus in Embodiment 3.

### DESCRIPTION OF THE EMBODIMENTS

Exemplary embodiments of the present invention will be described below with reference to the attached drawings.

Prior to describing specific embodiments, description will be made here of a blur correction process as an image process performed in each embodiment. In the blur correction process, first of all, an input image is acquired whose frequency component is lost due to blur (degradation) generated in an image capturing process. Next, a partial image area called a range block image is extracted from the input image. A degradation function, which is a function representing the blur appearing in the range block image due to the image capturing, is considered to be known.

Next, at least one domain block image (first domain block image) is acquired. The domain block image may be extracted from the input image or may be acquired from another image. The input image or the other image from which the domain block image is acquired is hereinafter referred to also as “a domain-block-acquiring image”.

Thereafter, the domain block image is resized to a same size as that of the range block image. The degradation function is then applied to the resized domain block image to produce a degraded domain block image (second domain block image).

Next, a correlation between the degraded domain block image and the range block image is calculated. In this calculation, a domain block image (third domain block image or corresponding domain block image) which is an original of the degraded domain block image whose correlation is determined to be high can be considered to correspond to a range block image before the blur is generated. For this reason, replacing the degraded range block image with the third domain block image enables performing the blur correction. Performing the above-described processes on all the range block images included in a correction target area of the input image makes it possible to produce an output image in which the blur in the correction target area are corrected.

### Embodiment 1

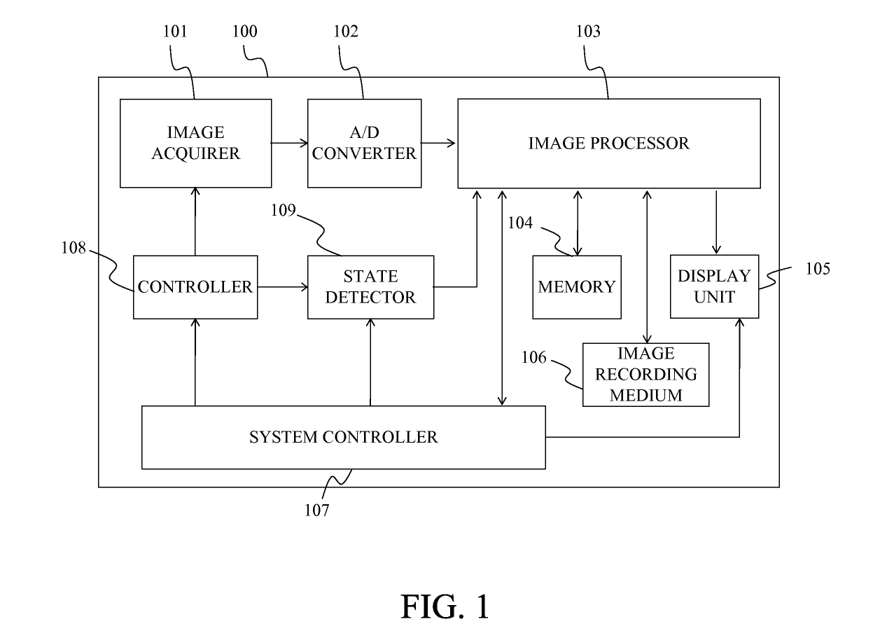

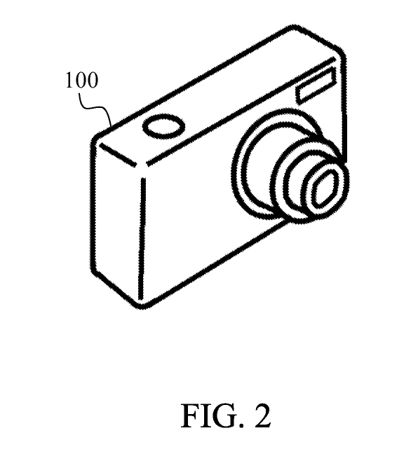

FIG. 1 illustrates a configuration of an image capturing apparatus 100, which is a first embodiment (Embodiment 1) of the present invention. The image capturing apparatus 100 performs the above-described blur correction process. FIG. 2 illustrates an appearance of the image capturing apparatus 100.

An image acquirer (image capturer) 101 includes an imaging optical system (image capturing optical system) and an image sensor (both not illustrated). The image sensor is a photoelectric conversion element such as a CCD (Charge Coupled Device) sensor and a CMOS (Complementary Metal-Oxide Semiconductor) sensor. When image capturing is performed, light entering the image acquirer 101 is condensed by the imaging optical system and then converted by the image sensor into an analog electrical signal. The analog electrical signal is converted by an A/D converter 102 into a digital signal (hereinafter referred to as “a digital image-capturing signal”), and the digital image-capturing signal is input to an image processor 103.

The image processor 103 performs predetermined image processes on the digital image-capturing signal to produce a captured image. The image processor 103 performs, on the captured image as the input image, the blur correction process for restoring the frequency component lost due to the image capturing. The blur correction process, the overview of which is as mentioned above, will be described later in detail. In a memory 104, the degradation function to be used in the blur correction process and image capturing condition information acquired by a state detector 109 and representing a state of the image acquirer 101 when image capturing is performed.

The degradation function is a function representing aberration, diffraction and defocus of the imaging optical system of the image acquirer 101 and representing image blur caused by shaking of the apparatus due to user's hand jiggling during the image capturing. The image capturing condition information contains an aperture value of the imaging optical system, a position of a focus lens (that is, an image capturing distance), a position of a zoom lens (that is, a focal length of the imaging optical system) and the like. The state detector 109 may acquire the image capturing condition information from either of a system controller 107 or a controller 108.

The image (output image) processed by the image processor 103 is stored in an image recording medium 106 in a predetermined format. With storing of the output image, the image capturing condition information may be stored in the image recording medium 106. In addition, the image processor 103 may perform the blur correction process after reading the image already stored in the image recording medium 106. The image stored in the image recording medium 106 is displayed on a display unit 105 such as a liquid crystal display.

The system controller 107 controls operations of the image sensor, the image processor 103 and the display unit 105, and controls storing and reading the image to and from the recording medium 106 the image. The controller 108 controls mechanical drive of the imaging optical system in response to an instruction from the system controller 107.

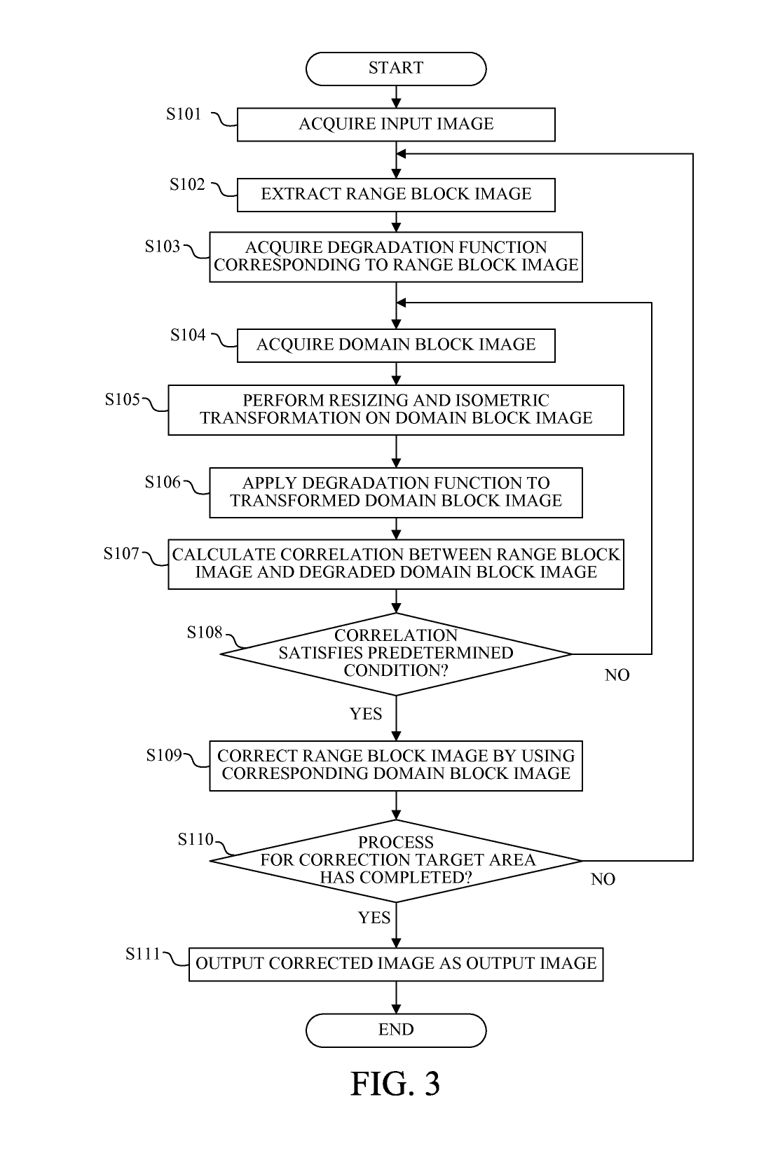

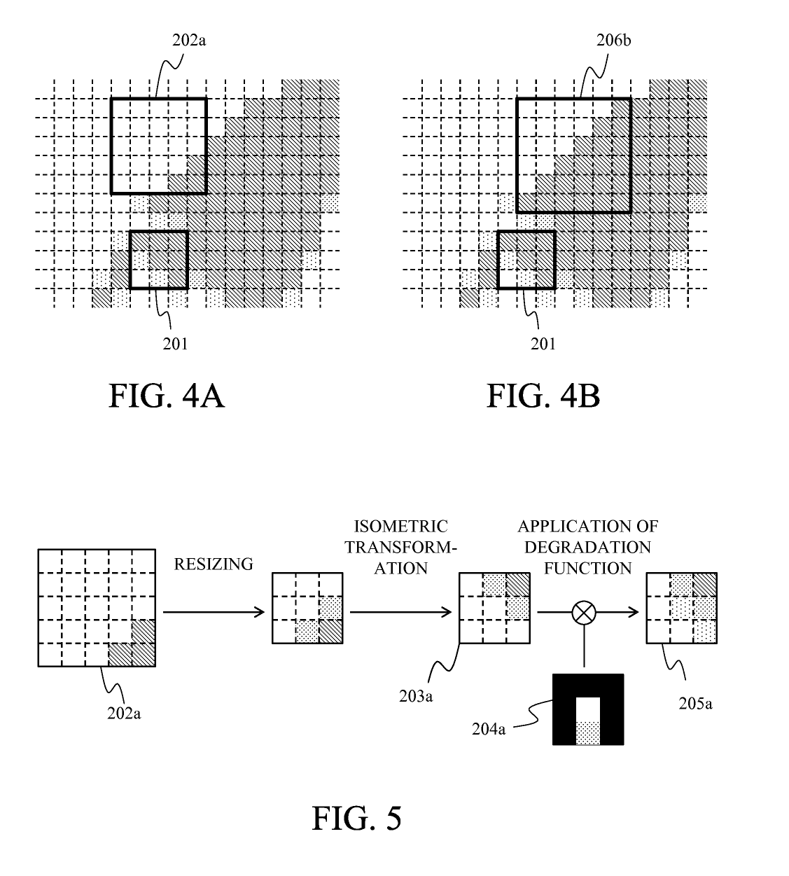

Next, detailed description will be made of the blur correction process performed by the image processor 103, with reference to a flowchart of FIG. 3 and to FIGS. 4A, 4B and 5. This process is performed by the image processor 103, which is an image processing computer, according to an image processing program as a computer program. The image processor 103 serves as an extractor, first and second acquirers, a first producer, a calculator, a selector and a second producer.

At step S101, the image processor 103 performs the predetermined image processes on the digital image-capturing signal from the image acquirer 101 to acquire (produce) the input image. The input image contains less information compared to that contained in an object space (original image) due to the blur as the degradation generated in the image capturing process. That is, at least part of frequency components of the object space is lost.

At step S102, the image processor 103 extracts the range block image from the correction target area of the input image on which the blur correction process is to be performed. The correction target area may be an entire area or a partial significantly blurred area or multiple significantly blurred areas of the input image. FIG. 4A illustrates part of the input image. The image processor 103 extracts a rectangular area 201 constituted by, for example, a 3×3-pixel matrix as the range block image 201. However, size (number of pixels), shape and extraction position of the range block image are not limited to the above ones. In addition, the image processor 103 may extract multiple range block images from the input image such that the range block images partially overlap with one another.

Moreover, the image processor 103 may subtract a direct-current component (average signal value) from the range block image. The image processor 103 performs the blur correction process by searching for the domain block image that has a structure homothetic to that of the range block image before the blur is generated. However, there is no correlation between a structure of the object space and an exposure of the image capturing apparatus 100, and thus the direct-current component corresponding to a luminance of the input image is dominantly affected by the exposure. For this reason, it is no problem that a luminance component of the range block image is already removed when the correlation calculation is performed. Furthermore, the homothetic shape to be searched for becomes easier to be found as a flexibility of the range block image and that of the domain block image decrease. This is simply because both the images have few signal-distribution patterns. Therefore, also removing the luminance component of the domain block image can make it easier to find a highly-correlated homothetic shape.

Description using expressions will be additionally made of the process below. Although the input image, the range block image and the domain block image each actually have multiple color signals such as R, G and B (Red, Green and Blue) signals, description will be continued below assuming, for ease of understanding, that the images are considered to each have a single color signal. When the multiple color signals are to be taken into consideration, it is enough to perform a similar process on each of the color signals. In addition, when searching for a homothetic shape corresponding to that of the range block image extracted from a certain color image (for example, a G image), the domain block image may be acquired alternatively from another channel image (for example, an R image or a B image). When symbol n_{R} represents a total number of pixels of the range block image, and symbol R represents a signal value vector whose components are signal values of the respective pixels, a signal vector P after the direct-current component is subtracted is expressed by following expression (1):

P=R−rₐᵥₑE (1)

where symbol rₐᵥₑ represents an average signal value (corresponding to the direct-current component) of the range block image, and symbol E represents an n_{R}-th order vector whose each component is 1. The average signal value rₐᵥₑ may be calculated by uniform weighting or may be calculated as a weighted average.

Next, at step S103, the image processor 103 acquires the degradation function corresponding to the extracted range block image from the memory 104. FIG. 5 illustrates a degradation function 204a corresponding to the range block image 201. The degradation function corresponding to the range block image is, as described above, the function representing the blur generated in the range block image 201 due to the image capturing. The blur includes the aberration, diffraction and defocus generated in the image acquirer 101 or the image blur generated during image capturing. The degradation function representing the blur caused by the aberration, diffraction and defocus is calculated from a design value or a measurement value of the image acquirer 101 and stored in the memory 104. In addition, the degradation function representing the blur caused by the image blur can be acquired by detecting a movement (shake) of the image capturing apparatus 100 during image capturing with, for example, the state detector 109 equipped with a gyro sensor. The degradation function is expressed as a PSF (Point Spread Function) or an OTF (Optical Transfer Function).

In order to correct the blur caused by the defocus, the image capturing apparatus 100 may include a distance-measuring device that acquires distance information of the object space.

In order to acquire the degradation function corresponding to the range block image, the image capturing condition information when image capturing to acquire the input image is performed, the extraction position of the range block image and the like are used. In addition, the degradation function is prepared for each color component (RGB) of the image. This is because when, for example, the degradation of the frequency component caused by the aberration is to be corrected, an influence of the aberration varies depending on variables such as a zoom state and an aperture value of the image acquirer 101, an image height and a wavelength. However, if there is a variable whose influence on the degradation function is small, such a variable may be excluded in deciding the degradation function.

Subsequently, at step S104, the image processor 103 acquires the domain block image (first domain block image) from the domain-block-acquiring image. As described above, the domain-block-acquiring image may be the input image or the other image. However, in view of a fact that a fractal characteristic of the object space is to be utilized, it is desirable that the domain-block-acquiring image include an object that is same as or similar to the input image. For instance, when the domain block image is to be acquired from the input image, a rectangular area 202a constituted by a 6×6-pixel matrix is extracted as the domain block image as illustrated in FIG. 4A. However, size (ratio of number of pixels with respect to the range block image) and shape of the domain block image and the extraction position thereof are not limited to the above ones.

Next, at step S105, as illustrated in FIG. 5, the image processor 103 performs resizing (size conversion) and isometric transformation on the domain block image to produce a transformed domain block image 203a. The isometric transformation is performed to increase number of candidates whose each correlation with the range block image is to be calculated, and the resizing is performed to calculate the correlation with the range block image. However, the resizing and isometric transformation are not necessarily essential. For instance, to calculate the correlation, the image processor 103 may alternatively resize the range block image so as to match the size of the range block image to that of the domain block image. In addition, when the image processor 103 has subtracted the direct-current component from the range block image, the image processor 103 subtracts the direct-current component also from the domain block image.

When symbol n_{D} represents a total number of pixels of the domain block image, and symbol D represents a signal value vector whose components are signal values of the respective pixels, a signal vector A after the direct-current component is subtracted is expressed by following expression (2):

Δ=ε(σ(D)−δₐᵥₑE) (2)

where symbol σ represents the resizing of an image having n_{D} pixels to an image having n_{R} pixels. For the resizing, bilinear interpolation or bicubic interpolation can be employed. Symbol δₐᵥₑ represents an average signal value of the domain block image, and symbol ε represents the isometric transformation.

The isometric transformation includes identical transformation, rotational transformation, inverse transformation and the like. Although description of this step is made of the case where the isometric transformation is performed after the resizing in order to reduce a calculation load, these processes may be performed in a reversed order.

Next, at step S106, as illustrated in FIG. 5, the image processor 103 applies the degradation function 204a to the transformed domain block image 203a. This consequently produces a degraded domain block image (second domain block image) 205a as the domain block image to be used for the correlation calculation. In applying the degradation function to the transformed domain block image, when, for example, the degradation function is the PSF, convolution of the degradation function is performed to the transformed domain-block image. When the degradation function is the OTF, a product of a Fourier-transformed transformed domain-block image and the OTF is calculated. FIG. 5 illustrates an example of performing convolution of the degradation function 204a to the transformed domain block image 203a to produce the degraded domain block image 205a.

Although description of this step is made of the case of applying the degradation function 204a after performing the resizing and the isometric transformation, these processes may be performed in a reversed order. In the latter case, the image processor 103 applies, to the domain block image 202a, a degradation function 204a acquired by performing a transform inverse to σ and ε.

Next, at step S107, the image processor 103 calculates the correlation between the range block image 201 and the degraded domain block image 205a. As a method of calculating the correlation, a method can be employed which calculates an absolute value sum of signal differences between corresponding pixels (that is, an absolute value sum of differences between the components of the vectors) of both the images. In this method, a correlation calculation formula f is expressed by following expression (3):

$$f = {\sum }_{i = 1}^{{n}_{R}} {w}_{i} \vert {ρ}_{1} - {δ}_{1} \vert \qquad ( 3 )$$

where symbol ρᵢ represents an i-th component of the signal vector P expressed by expression (1), symbol δᵢ represents an i-th component of the signal vector Δ expressed by expression (2), and symbol wᵢ represents a weight of the i-th component.

In this calculation, a contrast may be adjusted so as to maximize the correlation between the signal vector Δ and the signal vector P. That is, the coefficient c may be decided so as to minimize a value of |P−cΔ|. The coefficient c is, by using a least squares method, expressed by following expression (4):

$$c = \frac{P \cdot Δ}{{\vert Δ \vert}^{2}} \qquad ( 4 )$$

When the contrast adjustment is to be taken into consideration in the correlation calculation formula expressed by expression (3), it is enough to change |ρᵢ−δᵢ| to |ρᵢ−cδᵢ|.

As another method of calculating the correlation, an SSIM (Structure Similarity) may be used. The SSIM is expressed by the following expression (5):

f_{SSIM}(R,ε(σ(D)))=[L(R,ε(σ(D)))]^{α}[C(R,ε(σ(D)))]^{β}[S(R,ε(σ(D)))]^{γ} (5)

where symbols L, C and S represent evaluation functions respectively relating to the luminance, the contrast and other structures and each having a value from 0 to 1. As each of these values is closer to 1, two images to be compared with each other are closer to each other. Symbols α, β and γ represent parameters for adjusting weights of the respective evaluation items. When α=0, the correlation calculation in which the direct-current component (luminance) is subtracted is performed, which makes it unnecessary to perform the calculation expressed by expression (1). When β=0, it becomes unnecessary to take a scalar multiple (contrast adjustment) of an alternating-current component into consideration in calculating the correlation, which makes it unnecessary to perform the calculation expressed by expression (4).

Alternatively, multiple methods may be employed to calculate the correlation. In this case, it is enough to acquire a correlation value by each of the methods to decide a final correlation by using a weighted average, a linear sum or the like of the correlation values.

Next, at step S108, the image processor 103 determines whether or not the correlation acquired at step S107 satisfies a predetermined condition. If the correlation satisfies the predetermined condition, that is, the correlation between the range block image and the degraded domain block image is higher than a predetermined threshold, the image processor 103 selects the domain block image as a corresponding domain block image (third domain block image) which corresponds to the range block image. Thereafter, the image processor 103 proceeds to step S109. The corresponding domain block image 206b selected from the input image as the domain block acquiring image as illustrated in FIG. 4B corresponds to the range block image before the blur is generated. If the correlation is not higher than the predetermined threshold, the image processor 103 returns to step S104 to acquire a new domain block image. Alternatively, the image processor 103 may return to step S105 to recalculate the correlation by performing a new isometric transformation.

At step S109, the image processor 103 corrects the blur of the range block image by using the corresponding domain block image. For instance, the image processor 103 may produce a transformed corresponding domain block image produced by performing the resizing and isometric transformation on the corresponding domain block image and by replacing the range block image with the transformed corresponding domain block image. When the image processor 103 calculates the correlation by using expressions (1), (2) and (4), the image processor 103 can replace the signal vector R with a signal vector Γ expressed by following expression (6):

Γ=cε(σ(D)−δₐᵥₑE)+rₐᵥₑE (6)

Alternatively, the image processor 103 may correct the blur of the range block image by using a method such as learning-based super resolution that uses the corresponding domain block image as a reference image.

Next, at step S110, the image processor 103 determines whether or not the blur correction process has been completed for all the range block images extracted in the correction target area of the input image. The image processor 103 proceeds to step S111 if the process has been completed for all of them and returns to step S102 to extract new range block images if not.

At step S111, the image processor 103 produces the output image in which the blur in the correction target area has been corrected. The image processor 103 may additionally perform sharpening such as unsharp masking on the output image.

The above-described blur correction process enables providing the output image in which the frequency component lost in the input image due to the blur generated in the image acquirer 101 has been restored.

Next, description will be made of conditions desired to be taken into consideration for performing a more satisfactory blur correction process.

A first condition is a condition on the size of the domain block image acquired by the image processor 103 at step S104. It is desirable to decide the size of the domain block image depending on a relation between the degradation function corresponding to the domain block image (the function is hereinafter referred to as “a domain degradation function F_{D}”) and the degradation function corresponding to the range block image (the function is hereinafter referred to as “a range degradation function”). Since the domain block image is acquired with a certain image capturing apparatus except when the domain block image is a CG (Computer Graphics), not a little blur caused by aberration or diffraction is present therein. In this embodiment, since the blur of the range block image is corrected using the transformed domain block image (first domain block image after the resizing and isometric transformation), the transformed domain block image has to have a higher MTF than that of the range block image. In other words, a significant blur present in the transformed domain block image, namely, a large size of the domain degradation function makes it impossible to perform a satisfactory blur correction process.

For this reason, it is desirable that the domain degradation function after the domain block image is resized, namely, the size of G(F_{D}) be smaller than that of the range degradation function. The “size” of the degradation function in this embodiment is a parameter representing a spread of the degradation function. It is enough to define the size as, for example, an area in which value of the degradation function is higher than a predetermined value or an area in which a ratio of the value of the degradation function to an integral of the entire part of the degraded function is equal to or larger than a predetermined ratio. Deciding the size of the domain block image so as to satisfy the above-mentioned condition enables reducing a calculation irrelevant to the blur correction process.

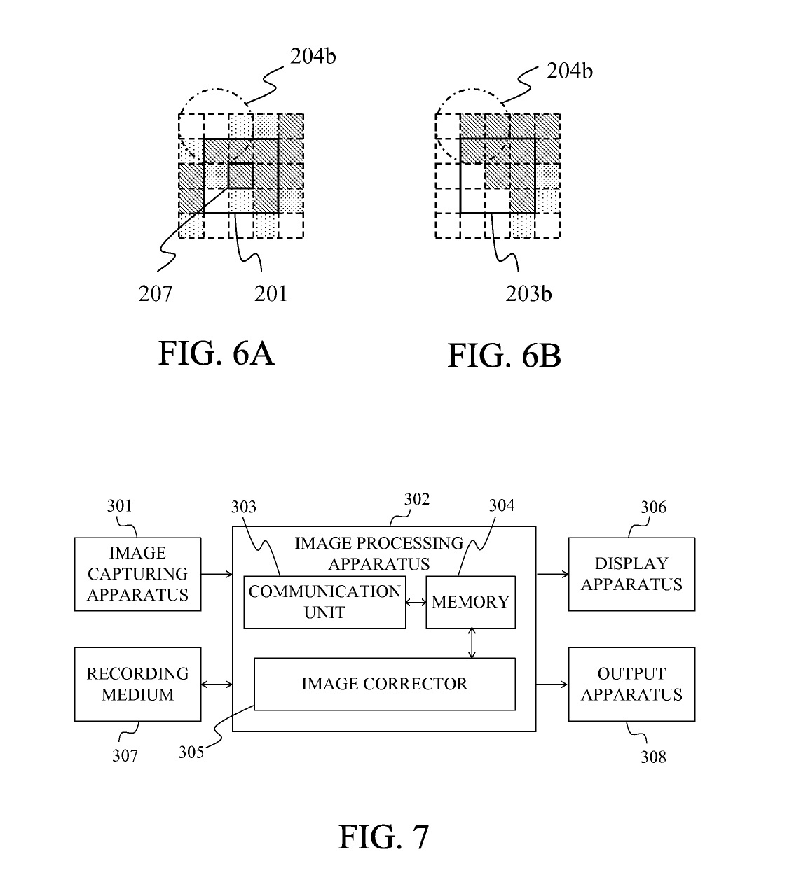

A second condition is a condition on the correlation calculation at step S107. It is desirable to provide, to a marginal side area in the range block image, a smaller correlation weight (wᵢ in expression (3)) than that provided to a central side area which is closer to a center of the range block image than the marginal side area. A reason therefor will be described with reference to FIGS. 6A and 6B. FIG. 6A illustrates, of the input image illustrated in FIG. 4B, a range block image 201 and its nearby area. An area denoted by reference numeral 207 is a central side area of the range block image 201. FIG. 6B illustrates a transformed corresponding domain block image 203b provided by performing the resizing and isometric transformation on the corresponding domain block image 206b illustrated in FIG. 4B. Description will be continued of a case where the range degradation function 204b corresponding to the range block image 201 has PSFs as indicated by dashed-dotted lines drawn in FIGS. 6A and 6B.

As can be understood from FIGS. 6A and 6B, an outside area of the range block image 201 and that of the transformed corresponding domain block image 203b generally have signal values completely different from each other. The same situation occurs also when each signal value of the outside area of the transformed corresponding domain block image 203b is zero. However, as illustrated by the dashed-dotted lines, since the range block image 201 and the transformed corresponding domain block image 203b are affected by the range degradation function 204b also from their outside, an error is superimposed on each of these block images 201 and 203b. The error becomes larger in a more marginal side area of the range block image 201. Therefore, it is desirable, in calculating the correlation, to provide a smaller weight to the marginal side area than that provided to the central side area. For instance, it is enough to provide a smaller weight to an area closer to a marginal edge. This enables selecting the corresponding domain block image with higher accuracy.

It is more desirable to decide the marginal side area in the range block image 201 depending on the range degradation function. This makes it possible to more accurately select the corresponding domain block image. For instance, in the case illustrated in FIG. 6A, since the size of the range degradation function 204b is equivalent to a 3×3-pixel matrix, it is enough to decide, as the marginal side area, a portion of the range block image 201 left after excluding the central side area 207 which is not affected by the range degradation function 204b from its outside area. When the range degradation function has an asymmetrical shape like the range degradation function 204b illustrated in FIG. 5, it is desirable that the marginal side area also have, corresponding thereto, an asymmetrical shape.

A third condition is a condition on the blur correction at step S109. In the blur correction, it is desirable to use only a central side area of the corresponding domain block image (transformed corresponding domain block image), which is left after a marginal side area is excluded from the corresponding domain block image. This is as described with reference to FIG. 6B. That is, an error with respect to the range block image 201 is generated in the marginal side area of the transformed corresponding domain block image 203b. Therefore, in order to perform a more accurate blur correction, it is desirable to use the central side area left after the marginal side area is excluded from the transformed corresponding domain block image 203b. Extracting the range block images at step S102 such that they overlap each other enables, without using the entire transformed corresponding domain block image, performing the blur correction on the entire input image.

It is further desirable to decide the marginal side area to be excluded from the transformed corresponding domain block image, depending on the range degradation function. This is based on the same reason as that described above.

A fourth condition is a condition on the size and shape of the range block image extracted at step S102. It is desirable to decide the size and shape of the range block image on a basis of the range degradation function. Setting the size and shape of the range block image to be similar to those of the range degradation function enables preventing any information necessary for the correction from lacking and preventing any information irrelevant to the correction from mixing in the information necessary for the correction.

The above-described conditions are desirable to be satisfied in order to perform the blur correction as satisfactory as possible. In addition, a correction of a distortion component (electronic distortion correction) in the input image by image processing may be performed along with the above-described blur correction process. In this case, it is necessary to remove, from the range degradation function to be applied to the transformed domain block image 203a at step S106, a distortion component included in the range degradation function. Moreover, it is desirable to perform the electronic distortion correction prior to step S107. This is because an accurate value of any remaining distortion component becomes impossible to know if the electronic distortion correction is performed after the blur correction process.

Furthermore, multiple types of range degradation functions may be acquired at step S103. In this case, the image processor 103 performs the processes of steps S106 to S109 on the multiple range degradation functions, selects a correction result evaluated as the most appropriate one and uses the selected correction result in producing the output image. For instance, when correcting the blur caused by the defocus without using distance information of the object space, the image processor 103 acquires the range degradation function corresponding to multiple defocus amounts and performs the processes of steps S106 to S109. Then, selecting, from the produced images, one whose defocus has been most sufficiently corrected of all of them enables producing an intended output image. As an example of a determination criterion for the defocus correction, a method can be employed which selects the produced image whose luminance or contrast is highest of all of the produced images.

This embodiment can realize an image capturing apparatus capable of producing an output image in which a frequency component whose MTF was significantly lowered due to the blur generated in image capturing of the object space is sufficiently restored.

### Embodiment 2

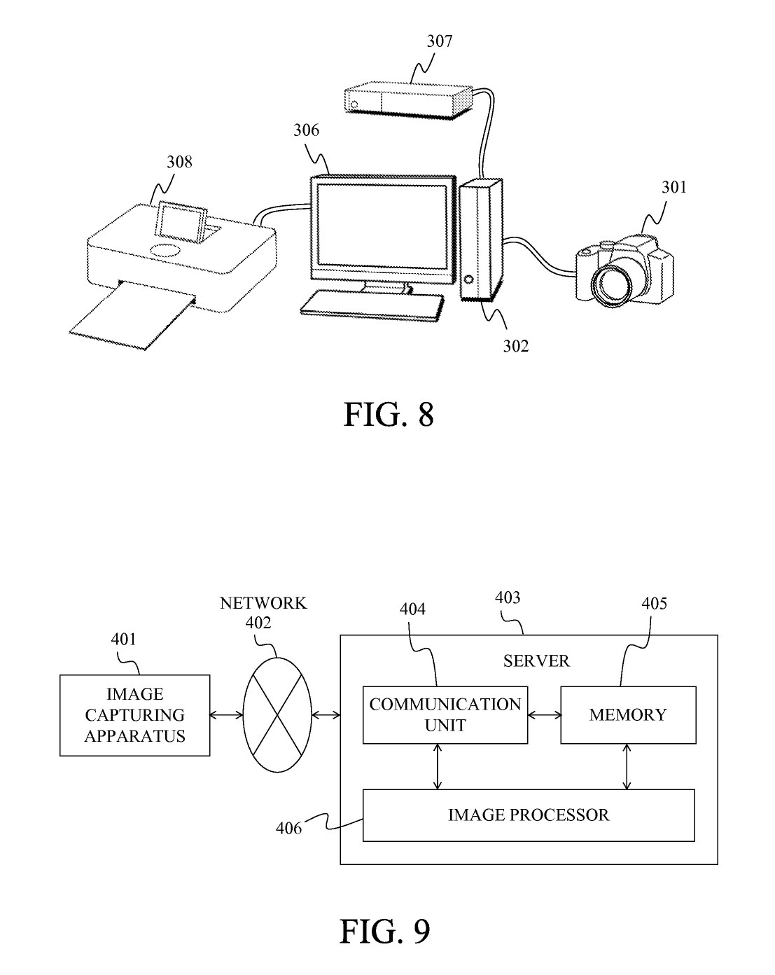

FIG. 7 illustrates a configuration of an image processing system that is a second embodiment (Embodiment 2) of the present invention. The system includes an image processing apparatus 302. FIG. 8 illustrates an appearance of the image processing system.

An input image acquired by an image capturing apparatus 301 is input via a communication unit 303 to the image processing apparatus 302 constituted by a computer. After the input image and image capturing condition information corresponding to when the image capturing was performed are stored in a memory 304, the blur correction process described in Embodiment 1 is performed by an image corrector (image processor) 305. The output image produced by the blur correction process is output via the communication unit 303 to at least one of a display apparatus 306, a recording medium 307 and an output apparatus 308. The display apparatus 306, such as a liquid crystal display or a projector, displays the output image. A user also can perform tasks while checking, during the blur correction process and the like, an image displayed by the display apparatus 306. The recording medium 307 is a semiconductor memory, a hard disk, a server on a network or the like. The output apparatus 308 is a printer or the like. The image processing apparatus 302 may have a function of performing, as needed, a development process and other image processes.

The blur correction process performed by the image corrector 305 included in the image processing apparatus 302 is basically same as that described in Embodiment 1 with reference to FIG. 3. However, at step S101, the image corrector 305 acquires an input image produced by image capturing performed by the image capturing apparatus 301. In addition, at step S103, the image corrector 305 acquires a degradation function corresponding to the image capturing apparatus 301 from the memory 304 prestoring degradation functions corresponding to multiple image capturing apparatuses. At this step, a model of the image capturing apparatus 301 connected to the image processing apparatus 302 is also used as a variable for deciding the degradation function. The image capturing condition information may be stored in a file in which the input image is stored or may be read from the image capturing apparatus 301.

This embodiment can realize an image processing apparatus capable of producing an output image in which a frequency component whose MTF was significantly lowered due to the blur generated in image capturing of the object space is sufficiently restored.

### Embodiment 3

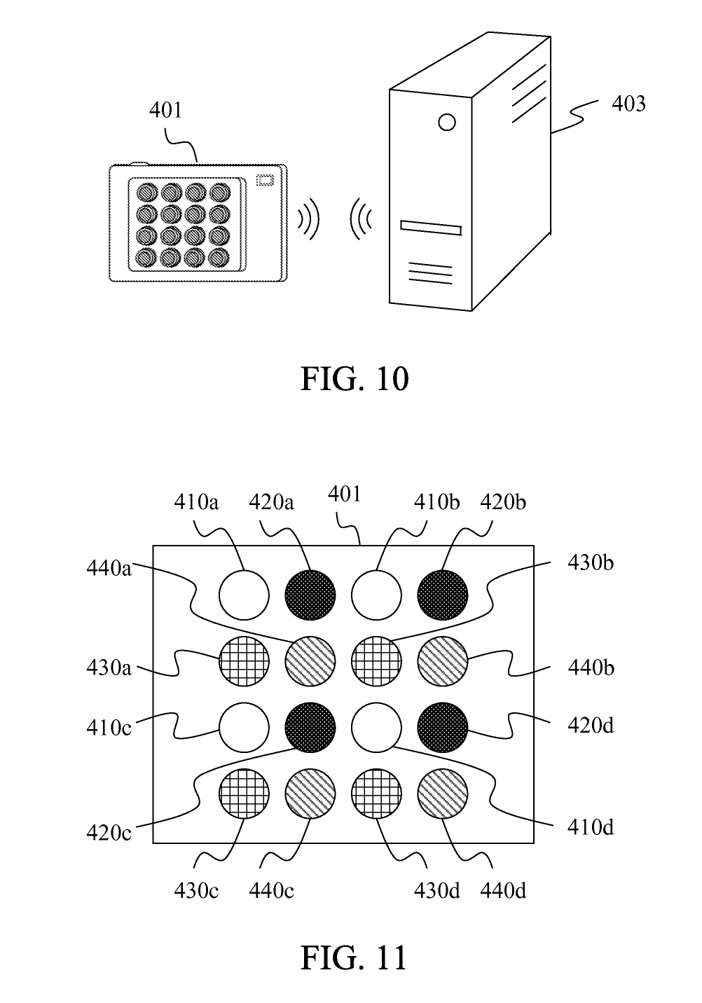

FIG. 9 illustrates a configuration of an image capturing system that is a third embodiment (Embodiment 3) of the present invention. FIG. 10 illustrates an appearance of the image capturing system.

A server 403 as a computer includes a communication unit 404 and is connected via a network 402 to an image capturing apparatus 401. In response to image capturing performed by the image capturing apparatus 401, an input image produced by the image capturing is automatically or manually sent to the server 403. The input image and image capturing condition information corresponding to when the image capturing was performed are stored in a memory 405 included in the server 403. Thereafter, an image processor 406 included in the server 403 performs the blur correction process described in Embodiment 1 to produce an output image. The output image is sent to the image capturing apparatus 401 and stored in the memory 405.

The image capturing apparatus 401 in this embodiment is a so-called multi-lens image capturing apparatus. That is, as illustrated in FIG. 11, four types of imaging optical systems whose focal lengths are mutually different and each of which includes four optical systems are arranged. Imaging optical systems 410a to 410d are wide-angle lenses, and imaging optical systems 420a to 420d are normal focal length lenses. In addition, imaging optical systems 430a to 430d are intermediate-telephoto lenses, and imaging optical systems 440a to 440d are telephoto lenses. However, type, number and arrangement of each imaging optical system are not limited to the above-described ones. Image sensors corresponding to the imaging optical systems may have mutually different number of pixels.

The blur correction process performed by the image processor 406 included in the server 403 is basically same as that described in Embodiment 1 with reference to FIG. 3. However, at step S101, the image processor 406 acquires, as an input image, one image produced by image capturing performed by the image capturing apparatus 401 through any one of the imaging optical systems. However, the image processor 406 may sequentially acquire, from the image capturing apparatus 401, images produced by image capturing through the mutually different imaging optical systems and perform the blur correction on all of the input images by repeating the blur correction process illustrated in FIG. 3 while switching the input image to be processed.

At step S104, the image processor 406 acquires a domain block image. At this step, the image processor 406 extracts the domain block image not only from the one input image, but also from other images produced by image capturing through other imaging optical systems of the image capturing apparatus 401. Although the imaging optical systems of the image capturing apparatus 401 are mutually different in their viewpoint and field angle, all of them are used for image capturing of a common object. For this reason, extracting the domain block image from the captured images enables increasing a blur correction effect. In particular, when the input images are the images produced by image capturing through the imaging optical systems 410a to 410d as the wide-angle lenses, extracting the domain block image from the images produced by image capturing through a further telephoto-side imaging optical system enables proving a higher blur correction effect. This is because the further telephoto-side imaging optical system has a larger image capturing magnification and thus the images produced therethrough each have a finer structure.

This embodiment can realize an image capturing system capable of producing an output image in which a frequency component whose MTF was significantly lowered due to the blur generated in image capturing of the object space is sufficiently restored.

Each of the above-described embodiments can provide, from an input image, a high-quality output image in which a frequency component whose MTF was significantly lowered due to the degradation caused by image capturing is sufficiently restored.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-255643, filed Dec. 11, 2013, which is hereby incorporated by reference herein in their entirety.

What is claimed is:

1. An image processing method comprising:
extracting a range block image from an input image produced by image capturing;
acquiring a degradation function representing degradation caused in the range block image by the image capturing;
acquiring at least one first domain block image from the input image or another image;
applying the degradation function to the first domain block image to produce a second domain block image;
calculating a correlation between the second domain block image and the range block image;
selecting from the at least one first domain block image, depending on the correlation, a corresponding domain block image that corresponds to the range block image; and
producing an output image by using the corresponding domain block image.

2. An image processing method according to claim 1, wherein the degradation function has a variable that is at least one of a model of an image capturing apparatus used for the image capturing, a state of an optical system of the image capturing apparatus corresponding to when the image capturing is performed, a color component of the input image and an extraction position of the range block image in the input image.

3. An image processing method according to claim 1, further comprising deciding size of the first domain block image depending on a relation between the degradation function and a domain degradation function that is a degradation function corresponding to the domain block image.

4. An image processing method according to claim 1, wherein the method comprises setting, in calculating the correlation, a marginal side area in the range block image to have a smaller weight than that of a central side area in the range block image.

5. An image processing method according to claim 1, wherein the method comprises, in producing the output image, using a central side area of the domain block image which is left after excluding a marginal side area thereof.

6. An image processing method according to claim 4, wherein the method comprises deciding the marginal side area depending on the degradation function.

7. An image processing method according to claim 5, wherein the method comprises deciding the marginal side area depending on the degradation function.

8. An image processing method according to claim 1, further comprising deciding size and shape of the range block image on a basis of the degradation function.

9. An image processing method according to claim 1, further comprising performing, on the input image, an image process for correcting a distortion component, prior to calculating the correlation.

10. An image processing apparatus comprising:
an extractor configured to extract a range block image from an input image produced by image capturing;
a first acquirer configured to acquire a degradation function representing degradation caused in the range block image by the image capturing;
a second acquirer configured to acquire at least one first domain block image from the input image or another image;
a first producer configured to apply the degradation function to the first domain block image to produce a second domain block image;
a calculator configured to calculate a correlation between the second domain block image and the range block image;
a selector configured to select from the at least one first domain block image, depending on the correlation, a corresponding domain block image that corresponds to the range block image; and
a second producer configured to produce an output image by using the corresponding domain block image.

11. An image capturing apparatus comprising:
an image capturer configured to perform image capturing; and
an image processing apparatus comprising:
an extractor configured to extract a range block image from an input image produced by the image capturing;
a first acquirer configured to acquire a degradation function representing degradation caused in the range block image by the image capturing;
a second acquirer configured to acquire at least one first domain block image from the input image or another image;
a first producer configured to apply the degradation function to the first domain block image to produce a second domain block image;
a calculator configured to calculate a correlation between the second domain block image and the range block image;
a selector configured to select from the at least one first domain block image, depending on the correlation, a corresponding domain block image that corresponds to the range block image; and
a second producer configured to produce an output image by using the corresponding domain block image.

12. A non-transitory computer-readable storage medium storing an image processing program as a computer program to cause a computer to execute an image process, the image process comprising:
extracting a range block image from an input image produced by image capturing;
acquiring a degradation function representing degradation caused in the range block image by the image capturing;
acquiring at least one first domain block image from the input image or another image;
applying the degradation function to the first domain block image to produce a second domain block image;
calculating a correlation between the second domain block image and the range block image;
selecting from the at least one first domain block image, depending on the correlation, a corresponding domain block image that corresponds to the range block image; and
producing an output image by using the corresponding domain block image.
